(19) United States
(12) Patent Application Publication
(10) Pub. No.: US 2024/0346766 A1
(43) Pub. Date: Oct. 17, 2024

(54) MODELLING METHOD AND SYSTEM, AND STORAGE CONTAINER COMPRISING THE SYSTEM

(71) Applicant: TOBII AB, DANDERYD (SE)

(72) Inventor: ANDREW RATCLIFF, DANDERYD (SE)

(21) Appl. No.: 18/633,582

(22) Filed: Apr. 12, 2024

(30) Foreign Application Priority Data
Apr. 13, 2023 (SE) 2350428-5

(51) Int. Cl. G06T 17/20; G06T 7/20

(52) U.S. Cl. CPC G06T 17/20; G06T 7/20

(57) ABSTRACT

A modelling method comprising receiving a plurality of images from an image sensor attached to a side of a hinged door facing an interior of a storage container, wherein each of the plurality of images is captured when the hinged door is at a corresponding one of a plurality of angular positions (θ) relative to the storage container, constructing a three-dimensional, 3D, model of contents within the storage container from the plurality of images and the corresponding plurality of angular positions.

### CROSS-REFERENCE TO RELATED APPLICATION

The present application claims priority to Swedish patent application No. 2350428-5, filed 13 Apr. 2023, entitled “MODELLING METHOD AND SYSTEM, AND STORAGE CONTAINER COMPRISING THE SYSTEM,” and is hereby incorporated by reference in its entirety.

### TECHNICAL FIELD

The present invention is related to techniques of modelling contents within a storage container, so that the status of the contents can be known without the user having to open the storage container.

### BACKGROUND

In recent years, manufacturers of storage containers, especially refrigerator manufactures, have been offering products with a display unit integrated on the exterior-facing side of the container/refrigerator. Often, these display units may have the capability of displaying an image of the interior volume of the container, so that contents within the container can be inspected without the user having to open the refrigerator.

However, as it is often the case, storage containers such as refrigerators can become crowded, so that certain items within the storage container may be obstructed from view by other items. In this scenario, the user would not be able to fully inspect the contents within the storage container by looking at the display unit. Instead, the user would be forced to open the storage container in order to identify obscured items. Having to open the storage container is, in itself, an inconvenience to the user. However, where the storage container is a refrigerator, opening and closing the door would cause the interior temperature of the refrigerator to rise, leading to a wastage of energy because additional electrical energy would need to be expended in order to restore the temperature inside the refrigerator. Furthermore, there may be situations in which the user is at a location remote to the storage container but wishes to inspect the contents within the storage container. In these situations, even if an image of the interior volume of the storage container could be delivered to the user remotely, e.g. via their smartphone, the user would still be unable to inspect any obscured items within the storage container.

Therefore, known techniques of displaying the contents in a storage container are inconvenient. Furthermore, where the storage container is a refrigerator, known techniques may lead to an unnecessary waste of electrical energy.

### SUMMARY

In accordance with the present invention, there is disclosed a modelling method comprising: receiving a plurality of images from an image sensor attached to a side of a hinged door facing an interior of a storage container, wherein each of the plurality of images is captured when the hinged door is at a corresponding one of a plurality of angular positions relative to the storage container; constructing a three-dimensional, 3D, model of contents within the storage container from the plurality of images and the corresponding plurality of angular positions.

The 3D model may be constructed using photogrammetry.

The 3D model may be a 3D mesh model, optionally a textured 3D mesh model.

The method may further comprise receiving the plurality of angular positions of the hinged door relative to the storage container from an angle sensor.

The plurality of angular positions may comprise a plurality of predetermined angular

positions, and the method further comprises instructing the image sensor to capture an image when the instantaneous angular position is substantially equal to one of the plurality of predetermined angular positions.

Optionally, every successive two of the plurality of predetermined angular positions are a constant angle apart.

The constant angle may be between 2 degrees and 10 degrees, optionally between 3 and 7 degrees, optionally 5 degrees.

The method may further comprise recording the instantaneous angular position at the time when an image is received from the image sensor as the angular position corresponding to the received image.

The method may further comprise determining the plurality of angular positions by analyzing the plurality of images.

The method may further comprise moving the image sensor relative to the hinged door as the angular position of the hinged door relative to the storage container changes.

The image sensor may be moved relative to the hinged door in a direction parallel to the rotational axis of the hinged door as the angular position of the hinged door relative to the storage container changes.

The method may further comprise updating the 3D model each time a plurality of new images captured at a corresponding plurality of angular positions is received as the hinged door is being moved away from and/or towards a closed position.

The method may further comprise displaying an image rendered from the 3D model on an image display. The image display may be mounted on an exterior-facing side of the hinged door.

The method may further comprise tracking a headpose of a viewer of the image display.

The method may further comprise changing the perspective from which the displayed image is rendered from the 3D model based on the headpose of the viewer.

There is also disclosed a computer program comprising instructions which, when executed by a processor, causes the processor to carry out the above method.

In accordance with the present invention, there is also disclosed a modelling system configured to model contents within a storage container, the system comprising: an image receiver configured to receive a plurality of images from an image sensor attached to a side of a hinged door facing an interior of the storage container, wherein each of the plurality of images is captured when the hinged door is at a corresponding one of a plurality of angular positions relative to the storage container; and a model constructor configured to construct a three-dimensional, 3D, model of the contents within the storage container from the plurality of images and the corresponding plurality of angular positions.

The model constructor may be configured to construct the 3D model using photogrammetry.

The 3D model may be a 3D mesh model, optionally a textured 3D mesh model.

The system may further comprise an angle receiver configured to receive the instantaneous angular position of the hinged door from an angle sensor. The plurality of angular positions may comprise a plurality of predetermined angular

positions, and the apparatus further comprises an image acquirer configured to instruct the image sensor to capture an image when the instantaneous angular position is substantially equal to one of the plurality of predetermined angular positions.

Optionally, every successive two of the plurality of predetermined angular positions are a constant angle apart.

The constant angle may be between 2 degrees and 10 degrees, optionally between 3 and 7 degrees, optionally 5 degrees.

The angle receiver may be further configured to record the instantaneous angular position at the time when an image is received from the image sensor as the angular position corresponding to the received image.

The system may further comprise an angle determiner configured to determine the plurality of angular positions by analyzing the plurality of images.

The model constructor may be further configured to update the 3D model each time the image receiver receives a plurality of new images captured at a corresponding plurality of angular positions as the hinged door is being moved away from and/or towards a closed position.

The system may further comprise the image sensor from which the modelling apparatus is configured to receive the plurality of images.

The system may further comprise an angle sensor from which the angle receiver is configured to receive the instantaneous angular position of the hinged door.

The system may further comprise an image display configured to display an image rendered from the 3D model.

The image display may be configured to be mounted on an exterior-facing side of the hinged door.

The system may further comprise a headpose tracking device configured to track a headpose of a viewer of the image display.

The system may be further configured to change the perspective from which the displayed image is rendered from the 3D model based on the headpose of the viewer.

There is also disclosed a storage container comprising a hinged door, and the above system.

The storage container may be further configured to move the image sensor relative to the hinged door as the angular position of the hinged door relative to the storage container changes.

The image sensor may be moved relative to the hinged door in a direction parallel to the rotational axis of the hinged door as the angular position of the hinged door relative to the storage container changes.

The storage container may be a refrigerator or a refrigerator compartment.

### LIST OF FIGURES

FIG. 1 depicts a storage container in accordance with an embodiment of the present invention.

FIG. 2 depicts the storage container of FIG. 1 in plan view.

FIGS. 3A and 3B depict images received from an image sensor of a modelling system in accordance with an embodiment of the present invention.

FIG. 4 depicts the storage container of FIG. 1 with its door closed.

FIG. 5 depicts a modelling system in accordance with an embodiment of the present invention.

### DETAILED DESCRIPTION

The present invention is related to modelling contents within a storage container, particularly storage containers with a hinged door. As used herein, the term “storage container” refers to any device which defines an interior volume of space in which contents can be stored. For example, the storage container may be a refrigerator or refrigerator compartment, and the contents may include food items. For another example, the storage container may be a cupboard. Often, contents are placed in the storage container at different positions along the width dimension and along the depth dimension of the storage container. For example, the storage container may become crowded. As a result, when looking into the interior volume of the storage container form a given perspective, not all of the contents will be visible as items placed towards the back of the storage container may become obscured by items placed towards the front of the storage container. Items placed towards the back of the storage container may also be partially obscured by items placed towards the front. In either case, it may be difficult to identify an obscured (fully or partially) item from that perspective.

In some scenarios, it may be desirable to be able to inspect the contents within a storage container without opening the door. Therefore, it has been known to provide an image sensor to capture images of the interior of the storage container, and the user would be able to inspect the contents in the storage container by viewing these images. That is, when the user desires to see the contents in the storage container, the image sensor may capture an image of the interior of the storage container showing the current state of the contents within the storage container, which image may be displayed on a display unit mounted or integrated on the exterior-facing side of the door. Therefore, the user is able to inspect the contents without opening the door of the storage container.

However, as mentioned above, contents are often placed within the storage container in such a way that items placed towards the back are fully or partially obscured by other items. In this case, images captured by the image sensor would fail to show the obscured items partially or completely. Therefore, the user may not be able to identify the obscured items. In this case, if the user wishes to inspect an obscured item, the user would have to open the door of the storage container, and attempt to find a perspective from which the previously obscured item would be visible. However, this may be undesirable because the user is obliged to open the door. For example, where the storage container is a refrigerator, opening the door results in a rise in temperature within the refrigerator, leading to an increased consumption of power due to the need to bring the temperature down again after the door is closed. For another example, the user may wish to inspect the contents within the storage container remotely, and thus may be unable to physically go to the storage container to inspect its contents. Finally, the need to physically open the door of the storage container may be an inconvenience to the user.

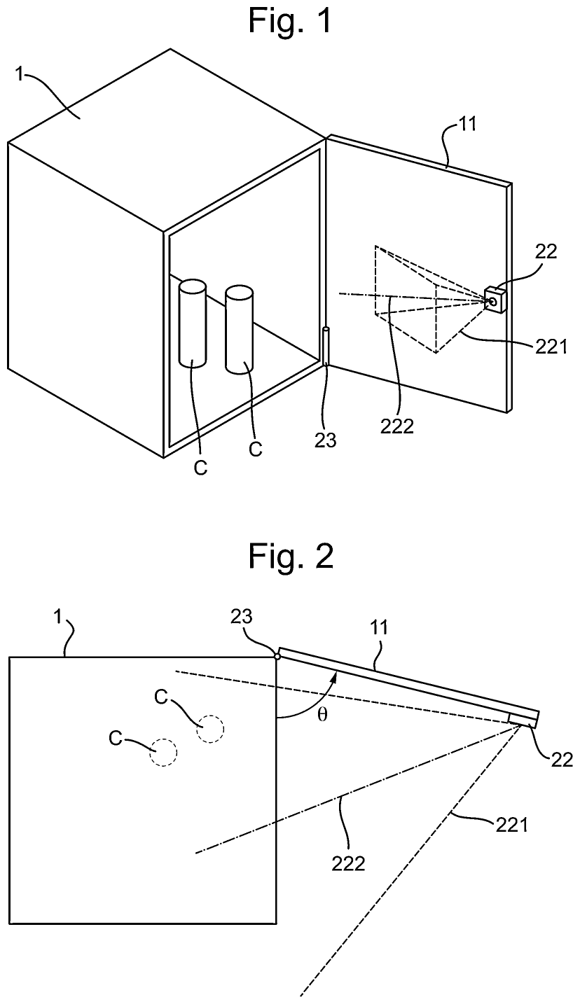

The present invention seeks to address the above drawbacks. FIG. 1 depicts a storage container 1 with a hinged door 11. In the state shown in FIG. 1, the hinged door 11 is open. As shown, for illustrative purposes only, the contents C in the storage container 1 are shown to comprise two items, which may be cans of soft drinks. As shown in the figure, an image sensor 22 is attached to the hinged door 11, specifically to the interior-facing side of the hinged door 11. Because the image sensor 22 is attached to the interior-facing side of the hinged door 11, the image sensor 22 may be capable of capturing images of the interior volume of the storage container 1.

FIG. 2 is a plan view of FIG. 1. As shown, the hinged door 11 is shown to be at an angle θ relative to the storage container 1. For illustrative purposes only, θ is defined such that θ=0° when the hinged door 11 is closed, and the value of θ increases as the hinged door 11 moves away from the closed position. Therefore, as the hinged door 11 moves through a plurality of angular positions θ, the image sensor 22 moves with the hinged door 11, and will capture images of the interior of the storage container 1 from different perspectives as the hinged door 11 moves through different angular positions θ.

As shown in FIG. 2, the optical axis 222 of the image sensor 22 may be angled away from the interior-facing surface of the hinged door 11, and instead be angled towards the hinge to an extent, so that a greater portion of the interior volume of the storage container 1 may fall within the field of view 221 of the image sensor 22 even when the hinged door 11 is open wide. As can be seen in FIG. 2, as an example, the hinged door 11 in open to an angular position θ of just under 90°, and the image sensor 22 is angled so that there is a large overlap between the field of view 222 of the image sensor 22 and the interior volume of the storage container 1.

The image sensor 22 may capture two-dimensional images. As the hinged door 11 moves through a plurality of angular positions θ, the image sensor 22 may capture two-dimensional images from a plurality of perspectives. Because the plurality of images are captured from different perspectives, these images may contain adequate information from which a three-dimensional model of the contents C may be constructed.

The image sensor 22 may be attached at a fixed position on the interior-facing side of the hinged door 11. The fixed position of the image sensor 22 may be known, and may be taken into account when constructing the three-dimensional model of the contents C. In particular, the image sensor 22 may be located at a known perpendicular distance to the rotational axis of the hinge (not shown) of the hinged door 11. In such an arrangement, the image sensor 22 may move along a circular arc as the hinged door 11 moves through a plurality of angular positions θ. That is, the image sensor 22 may move at a constant radius measured from the rotational axis of the hinge.

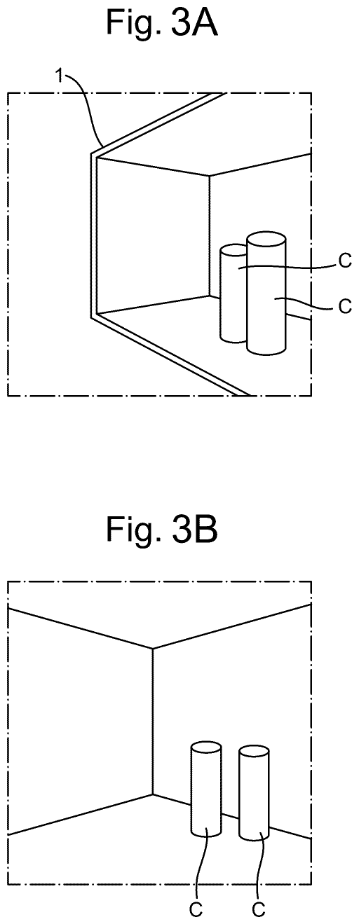

FIGS. 3A and 3B depict examples of images captured by the image sensor 22. Specifically, the image depicted in FIG. 3A may be captured when the hinged door 11 is open at a certain angular position θ. The image depicted in FIG. 3B may be one which is captured when the hinged door 11 is closed (i.e. θ=0°) . As can be seen, in FIG. 3A, for illustrative purposes only, one of the two items constituting the contents C is partially obscured by the other item. By contrast, in FIG. 3B where the image is captured from a different perspective, both items constituting the contents C are fully visible. It is to be understood that FIGS. 3A and 3B are only examples of images captured when the hinge door is a two particular angular positions θ, intended to demonstrate the effect of changing the perspective. It is to be understood that the plurality of images captured by the image sensor 22 may comprise images captured at intermediate angular positions θ of the hinged door.

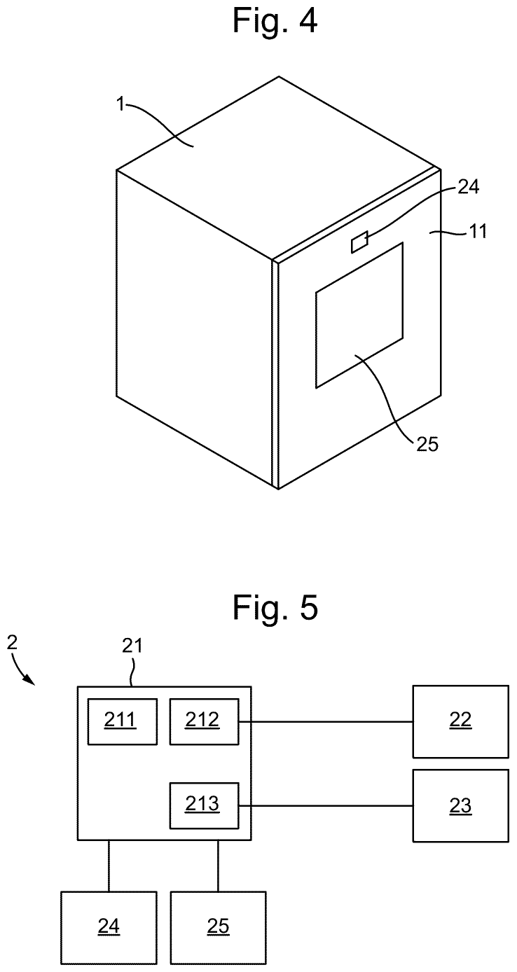

FIG. 4 depicts the storage container 1 with its hinged door 11 closed. The three-dimensional model of the contents C may be presented on an image display 25 on the exterior-facing side of the hinged door 11.

FIG. 5 schematically depicts a modelling system 2 in accordance with an embodiment of the present invention. As shown, the modelling system 2 comprises an image receiver 212. The image receiver 212 may be part of a modelling controller 21. The image receiver 212 is configured to receive a plurality of images from the image sensor 22 described above. In particular, the image receiver 212 may receive a plurality of images form the image sensor 22 when the hinged door 11 is at a corresponding plurality of angular positions θ relative to the storage container 1. As shown in FIG. 5, the modelling system 2 also comprises a model constructor 211 configured to construct a three-dimensional model of the contents C within the storage container 1. The model constructor 211 is configured to construct the three-dimensional model from the plurality of images captured by the image sensor 22 and the corresponding plurality of angular positions θ. That is, each of the plurality of images used by the model constructor 211 to construct the three-dimensional model may be associated with a particular angular position θ of the hinged door 11 at which the image is captured. It is to be understood that not all of the images captured by the image sensor 22 need be used to construct the three-dimensional model. Instead, the construction of the three-dimensional model may be based on some of the images captured by the image sensor 22.

The modelling controller 21 may be implemented using generic computing means having generic input/output interfaces. The modelling controller 21 may comprise one or more processors, and memory.

Although FIGS. 1 and 2 show a hinged door 11 which can rotate about a vertical axis of rotation, it is to be understood that the hinged door 11 may be hinged in a different direction. For example, as is common in certain overhead compartments, the hinged door 11 may be hinged at the top, so that the hinged door 11 rotates about a horizontal axis of rotation. Of course, the hinged door 11 may be hinged in any arbitrary direction as long as it covers an adequate range of angular positions θ in order for adequate image data to be captured for the construction of the tree-dimensional model.

Using the plurality of images and the corresponding plurality of angular positions θ, the three-dimensional model may be constructed using photogrammetry. As used herein, the term “photogrammetry” refers to the extraction of three-dimensional measurements from two-dimensional images. Photogrammetry may be advantageously employed because of the combination of displacement and rotation of the image sensor 22, with the hinge serving as a fixed point. That is, as the image sensor 22 simultaneously rotates and translates, each new image captured from a new perspective may reveal details about the contents C which complement previous images, and photogrammetry may be used to consolidate all the details captured in the images into a three-dimensional model. Various image processing techniques may be used in conjunction with, or as part of, photogrammetry. For example, the images captured by the image sensor 22 may be adjusted to have similar brightness and/or contrast. For example, edge detection may be applied to the images captured by the image sensor 22. Using feature detection techniques, items constituting the contents C in the storage container 1 may be identified. In particular, the model constructor 211 may match an item identified in one captured image to the same item captured in another image. That is, the model constructor 211 may recognise that a particular item appears in several images captured by the image sensor 22 as it moves during opening/closing of the hinged door through different positions within the field of view 222 of the image sensor 22. Various known object detection techniques may be used to track an item as it appears in different captured images.

The three-dimensional model constructed by the model constructor 211 may be of various types. For example, for simplicity, the 3D model may be a point cloud model. However, a point cloud model may have a disadvantage in that items may appear to be translucent, which may be difficult for the user to interpret. As an alternative, the three-dimensional model may be a 3D mesh model. That is, items constituting the contents C may be represented as 3D mesh objects. In addition, the 3D mesh model may be textured. That is, in addition to polygons describing the geometric shapes of the items constituting the contents C, the textured 3D mesh model may comprise a representation of the surface features of these items, including colours and surface shapes. For example, texture information may be represented by bitmap images which are mapped onto the 3D mesh objects.

The angular position θ at which each of the plurality of the images captured by the image sensor 22 may be obtained in a variety of ways.

For example, as shown in FIGS. 1 and 2, the modelling system 2 may comprise an angle sensor 23. The modelling system 2 may comprise an angle receiver 213 configured to receive the angular position θ of the hinged door 11 from the angle sensor 23. The angle receiver 213 may be part of the modelling controller 21. Specifically, the angle sensor 23 may detect the instantaneous angular position θ of the hinged door. The angle receiver 213 may receive the instantaneous angular position θ of the hinged door 11 from the angle sensor 23. As shown in FIG. 5, the angle receiver 213 may be part of the modelling controller 21.

As shown in FIGS. 1 and 2, the angle sensor 23 may be attached to the storage container 1 and the hinged door 11 at the rotational axis of the hinge. The angle sensor 23 may be integrated into a hinge securing the hinged door 11 to the storage container 1. In FIG. 1, the angle sensor 23 is shown to be installed towards the bottom of the storage container 1, but it is to be understood that the angle sensor 23 can be installed at other positions as appropriate.

The angle sensor 23 may be variously implemented. For example, the angle sensor 23 may be a rotary potentiometer, which represents the angular position θ by producing a variable electrical resistance. For another example, the angle sensor 23 may be an optical encoder. For another example, the angle sensor 23 may be a stepper motor driven in reverse (i.e., as a generator), which produces electrical pulses as output as the hinged door 11 rotates through a plurality of angular positions θ. As yet another example, the angle sensor 23 may comprise a series of microswitches arranged to be actuated when the hinged door 11 is at a corresponding one of the plurality of angular positions θ.

In an arrangement, the instantaneous angular position θ of the hinged door 11 may be used to trigger the capture of images. Specifically, a plurality of predetermined angular positions θ₁, θ₂, . . . , θ_{N} may be defined. The plurality of predetermined angular positions θ₁, θ₂, . . . , θ_{N} may be stored by the modelling system 2, or more specifically the modelling controller 21. The modelling system 2 may monitor the instantaneous angular position θ of the hinged door 11 via signals received from the angel sensor 23.

When the instantaneous angular position θ is equal to one of the predetermined angular positions θ₁, θ₂, . . . , θ_{N}, the modelling system 2 may cause the image sensor 22 to capture an image. Specifically, the modelling system 2 may further comprise an image acquirer (not shown) configured to instruct the image sensor 22 to capture an image when the instantaneous angular position θ is substantially equal to one of the plurality of predetermined angular positions θ₁, θ₂, . . . , θ_{N}. Therefore, each of the captured images may be associated with the corresponding one of the predetermined angular positions θ₁, θ₂, . . . , θ_{N}.

In use, the hinged door 11 will sweep through a range of angular positions θ every time the user opens and closes the hinged door 11. For example, the user may open the hinged door 11 in order to access the contents C stored within the storage container 1. The plurality of predetermined angular positions θ₁, θ₂, . . . , θ_{N} may cover a range of angular positions θ of the hinged door 11. The predetermined angular positions θ₁, θ₂, . . . , θ_{N} may cover the full range of angular positions through which the hinge allows the hinged door 11 to physically move through.

However, it may not always be useful to capture images when the hinged door 11 is at an angular position θ greater than a certain angle, as little or none of the interior volume of the storage container 1 may fall within the field of view 222 of the image sensor 22 when the hinged door 11 is wide open. For example, when the hinged door 11 is opened to an angular position θ of 180°, the image sensor 22 may point completely away from the interior volume of the storage container 1, so that images captured in this angular position would not be useful for modelling the contents C within the storage container 1. As such, the plurality of predetermined angular positions θ₁, θ₂, . . . , θ_{N} may cover only a portion of the full physical range of rotation of the hinged door 11. For example, the predetermined angular positions θ₁, θ₂, . . . , θ_{N} may cover angular positions θ from 0° to about 70°, 80°, 90°, 100°, 110°, or 120°, for example.

When the user opens and closes the hinged door 11, the user may not necessarily open the hinged door 11 as widely as the hinge allows, and may not even open the hinged door 11 wide enough to exceed the largest angle amongst the plurality of predetermined angular positions θ₁, θ₂, . . . , θ_{N}. Instead, the user may open the hinged door 11 just enough to access the contents C within the storage container 1, and may then close the hinged door 11. Therefore, when the hinged door 11 is opened and closed, the hinged door 11 may not necessarily move through every one of the predetermined angular positions θ₁, θ₂, . . . , θ_{N}. Nevertheless, the modelling system 2 may be configured to instruct the image sensor 22 to capture images corresponding to the subset of the predetermined angular positions θ₁, θ₂, . . . . θ_{N} that are swept through by the hinged door 11, which may yield images captured from enough different perspectives for the three-dimensional model to be constructed.

The predetermined angular positions θ₁, θ₂, . . . , θ_{N} may be evenly spaced. That is, every successive two of the plurality of predetermined angular positions θ₁, θ₂, . . . , θ_{N} may be a constant angle apart. For example, the constant angle may be about 2°, 3°, 4°, 5°, 6°, 7°, 8°, 9° or 10°. In particular, a constant angle of 5° may provide a suitable balance between capturing enough information for an accurate construction of the three-dimensional model of the contents C and limiting the amount of image data that needs to be processed. At a constant angle of 5°, 18 or 19 images may be captured as the hinged door 11 rotates through 90°. A higher number of images may be captured. For example, about 30 images may be captured. If 30 images are to be captured within a rotation of 90°, the constant angle may be about 3°.

As an alternative to a constant angle, the predetermined angular positions θ₁, θ₂, . . . , θ_{N} may be unequally spaced. For example, the predetermined angular positions θ₁, θ₂, . . . , θ_{N} may be spaced further apart as the angular position θ of the hinged door increases towards a fully open position. This may be advantageous because less and less of the interior volume of the storage container I may fall within the field of view 222 of the image sensor 22 as the angular position θ of the hinged door 11 exceeds a certain value. Therefore, images captured at the larger angular positions θ may contain less useful information for the construction of the three-dimensional model of the contents C.

As an alternative to triggering the capture of images at predetermined angular positions, the angle receiver 213 may instead be configured to record the instantaneous angular position θ of the hinged door 11 when an image is received from the image sensor 22. For example, the image sensor 22 may be configured to capture images at regular time intervals irrespective of the instantaneous angular position θ, and the modelling system 2 may take the reception of an image from the image sensor 22 as a trigger to record the instantaneous angular position θ. The modelling system 2 may record the instantaneous angular position θ by instructing the angle receiver 213 to interrogate the angle sensor 23 at the time when an image is received from the image sensor 22. For this purpose, the image sensor 22 may be configured to capture images at a suitable frame rate. For example, the image sensor 22 may be configured to capture images at about 5, 10, 20 or 30 frames per second, for example. With this arrangement, the plurality of angular positions θ at which images are captured will generally be unequally spaced and will depend on the user's control of the hinged door 11. Because each of the captured images is associated with the angular position θ at which it is captured, the three-dimensional model of the contents C can be accurately constructed.

As yet another alternative, instead of obtaining the plurality of angular positions θ using an angle sensor 23, the plurality of angular positions θ may be obtained by other means. For example, the plurality of angular positions θ may be obtained by analyzing the plurality of images captured by the image sensor 22. For example, the modelling system 2 may further comprise an angle determiner (not shown) configured to determine the plurality of angular positions θ by analyzing the plurality of images captured by the image sensor 22. The plurality of angular positions θ may be determined from the plurality of images by means of image processing techniques and spatial calculations.

In particular, because the movement of the image sensor 22 may be confined to a known trajectory, so that the image sensor 22 may have only one degree of freedom of movement, the plurality of angular positions θ may be reliably determined from the plurality of images captured by the image sensor 22. That is, in contrast to other unrelated imaging techniques in which the image sensor has two or more degrees of freedom (up to six, namely three axes of translation and three axes of rotation), the amount of image data needed to accurately deduce the plurality of angular positions from the captured images may be greatly reduced. By determining the plurality of angular positions θ from an analysis of the plurality of captured images, an angle sensor 23 may be entirely dispensed with. This may be advantageous because the modelling system 2 may be retrofitted to an existing storage container 1 without needing to alter the door hinge.

As noted above, each time the user opens and closes the hinged door 11, the hinged door 11 will sweep through a plurality of angular positions θ, and a plurality of images will be captured by the image sensor 22. Typically, the user opens the storage container 1 in order to access the contents C or to add or remove items from the storage container 1. Therefore, the opening and closing of the hinged door 11 may serve as an indication that the contents C are likely to have changed. Therefore, it may be advantageous to update (i.e., to construct afresh) the three-dimensional model new images are captured as the hinged door 11 is being moved away from and/or towards a closed position of the hinged door 11.

The modelling system 2 may determine that the hinged door 11 has been opened and closed by determining that the angular position θ of the hinged door 11 has increased from 0° to a certain positive value, followed by a decrease back to 0°. Alternatively, the modelling system 2 may determine that the hinged door 11 has been opened and closed when a plurality of new images captured by the image sensor 22 at a corresponding plurality of angular positions θ has been received.

Furthermore, as changes to the contents are likely to have been made by the user

shortly before the hinged door 11 is closed, the modelling system 2 may be configured to receive images from the image sensor 22 only when the hinged door 11 is being closed (and not when the hinged door 11 is being opened). Images captured when the hinged door 11 is being opened may not be useful because the contents C visible in these images are likely to be the same as in the previous state when the user last accessed the contents C. Therefore, by configuring the modelling system 2 to receive images from the image sensor 22 only when the hinged door 11 is closing may reduce the amount of image data to be processed.

As noted above, by constructing a three-dimensional model of the contents C within the storage container 1, it may be possible to present the three-dimensional model to the user without the user having to open the hinged door 11. One way of presenting the three-dimensional model to the user is to display an image rendered from the three-dimensional model on an image display 25. As shown in FIG. 4, the image display 25 may be mounted or integrated on the storage container 1. Specifically, the image display 25 may be mounted or integrated on the exterior-facing side of the hinged door. Alternatively, the image display 25 may be mounted on an exterior-facing side of the storage container 1 other than the hinged door 11. As such, the user may be able to inspect the contents C by viewing the image display 25.

The three-dimensional model may additionally or alternatively be presented to the user remotely. For example, the three-dimensional model may be presented to the user via the display of a smartphone or tablet, or of an external computer. This may enable the user to inspect the contents C in the storage container 1 when the user has no physical access to the storage container 1.

Irrespective of whether the image display 25 is mounted/integrated on the storage container 1 or is part of a smartphone, tablet or external computer, the image display 25 may be a non-stereoscopic display, or may be a stereoscopic display. Suitable stereoscopic display technologies include holographic and light field displays. A stereoscopic display may project a different image to each of the viewer's eyes, and may thus allow the viewer to perceive depth without having to change perspective (e.g. by moving their head).

The image to be displayed may be rendered at various perspectives from the three-dimensional model from the contents C. This may enable the user to inspect items which may otherwise be obscured by another item. For example, the displayed image may repeatedly cycle through a range of perspectives from the which the three-dimensional model is rendered. In arrangements where the three-dimensional model is presented on a hand-held device such as a smartphone, the user may be able to control the perspective from which the displayed image is rendered from the three-dimensional model by tilting the hand-held device, which device may include accelerometers and gyroscopic sensors capable of measuring the tilt of the hand-held device.

Alternatively, or additionally, as shown in FIG. 4, a headpose tracking 24 may be provided to track the headpose of a viewer of the image display 25. Based on the headpose of the viewer, the perspective from which the displayed image is rendered from the three-dimensional model may be changed. For example, the perspective of the displayed image may change in such a way as to give the illusion that the hinged door 11 is transparent, so that the displayed image as perceived by the viewer would be similar to what the viewer would see if the hinged door 11 were open. Alternatively, the change in perspective from which the displayed imaged is rendered may be exaggerated relative to changes in the headpose of the viewer. This may be advantageous as the viewer may be able access a large range of perspectives with relatively small movements of their head.

The headpose tracking device 24 may be constructed in accordance with various known techniques. For example, the headpose tracking device 24 may be constructed in accordance with WO 2019/067903 A1, which is herein incorporated by reference in its entirety.

As with the image display 25, the headpose tracking device 24 may also be mounted on the exterior-facing side of the hinged door 11, as shown in FIG. 4. If the three-dimensional model is presented on a smartphone display, the headpose tracking device 24 may be integrated in the smartphone. For example, the headpose tracking device may be implemented using a camera already existing on a smartphone.

As noted above, the image sensor 22 may be attached to the hinged door 11 at a fixed position. However, depending on the focal length of the image sensor 22 and the size of the storage container 1, the image sensor 22 may cover only a portion of the interior volume of the storage container 1. Increasing the field of view 222 of the image sensor 22 may enable a larger portion of the interior volume of the storage container 1 to be captured, but this may come at the expense of image distortions. Furthermore, some storage containers 1 may have shelves (not shown) which may block the view of some of the contents C from the fixed position of the image sensor 22.

Therefore, it is understood that several of the image sensor 22 described above may be provided at different positions. For example, several image sensors 22 may be provided at different positions along a line parallel to the rotational axis of the hinge of hinged door 11. In other words, several image sensors may be provided at different vertical positions on the hinged door 11. Additionally, or alternatively, as some storage containers 1 may have double doors, an image sensor 22 may be provided on each of the doors. In arrangements where multiple image sensors 22 are employed, the three-dimensional model of the contents C may be constructed using the images captured by some or all of these image sensors 22. As an alternative or in addition to providing several image sensors 22, the image

sensor 22 may move relative to the hinged door 11 as the angular position θ of the hinged door 11 relative to the storage container 1 changes. For example, the position of the image sensor 22 may change according to a one-to-one relationship with the angular position θ of the hinged door 11. For example, the image sensor 22 may move in a direction parallel to the rotation axis of the hinged door 11 as the angular position θ of the hinged door 11 relative to the storage container 1 changes. That is, the image sensor 22 may move up and down as the hinged door 11 is opened and closed. The movement of the image sensor 22 may be effected affected by a passive mechanical system which is actuated by the rotation of the hinged door 11 at the hinge. Alternatively, the position of the image sensor 22 may be hinged using electromechanical means, such as a screw shaft or belt actuated by a stepper motor or servomotor.

1. A computer-implemented modelling method comprising:
receiving a plurality of images from an image sensor attached to a side of a hinged door facing an interior of a storage container, wherein each of the plurality of images is captured when the hinged door is at a corresponding one of a plurality of angular positions (θ) relative to the storage container;
constructing a three-dimensional, 3D, model of contents within the storage container from the plurality of images and the corresponding plurality of angular positions.

2. The method of claim 1, wherein the 3D model is constructed using photogrammetry and/or wherein the 3D model is a 3D mesh model, optionally a textured 3D mesh model.

3. The method of claim 1, further comprising receiving the plurality of angular positions of the hinged door relative to the storage container from an angle sensor, wherein the plurality of angular positions comprises a plurality of predetermined angular positions, and the method further comprises instructing the image sensor to capture an image when the instantaneous angular position is substantially equal to one of the plurality of predetermined angular positions.

4. The method of claim 3, wherein every successive two of the plurality of predetermined angular positions are a constant angle apart and/or the constant angle is between 2 degrees and 10 degrees, optionally between 3 and 7 degrees, optionally 5 degrees.

5. The method of claim 4, further comprising recording the instantaneous angular position at the time when an image is received from the image sensor as the angular position corresponding to the received image.

6. The method of claim 1, further comprising moving the image sensor relative to the hinged door as the angular position of the hinged door relative to the storage container changes and/or wherein the image sensor is moved relative to the hinged door in a direction parallel to the rotational axis of the hinged door as the angular position of the hinged door relative to the storage container changes.

7. The method of claim 1, further comprising updating the 3D model each time a plurality of new images captured at a corresponding plurality of angular positions is received as the hinged door is being moved away from and/or towards a closed position.

8. The method of claim 1, further comprising displaying an image rendered from the 3D model on an image display and/or wherein the image display is mounted on an exterior-facing side of the hinged door.

9. The method of claim 8, further comprising tracking a headpose of a viewer of the image display and/or further comprising changing the perspective from which the displayed image is rendered from the 3D model based on the headpose of the viewer.

10. A modelling system configured to model contents within a storage container, the system comprising:
an image receiver configured to receive a plurality of images from an image sensor attached to a side of a hinged door facing an interior of the storage container, wherein each of the plurality of images is captured when the hinged door is at a corresponding one of a plurality of angular positions (θ) relative to the storage container; and
a model constructor configured to construct a three-dimensional, 3D, model of the contents within the storage container from the plurality of images and the corresponding plurality of angular positions.

11. The system of claim 10, wherein the model constructor is configured to construct the 3D model using photogrammetry and/or wherein the 3D model is a 3D mesh model, optionally a textured 3D mesh model.

12. The system of claim 10, further comprising an angle receiver configured to receive the instantaneous angular position of the hinged door from an angle sensor and/or wherein the plurality of angular positions comprises a plurality of predetermined angular positions, and the apparatus further comprises an image acquirer configured to instruct the image sensor to capture an image when the instantaneous angular position is substantially equal to one of the plurality of predetermined angular positions.

13. The system of claim 10, wherein every successive two of the plurality of predetermined angular positions are a constant angle apart and/or wherein the constant angle is between 2 degrees and 10 degrees, optionally between 3 and 7 degrees, optionally 5 degrees.

14. The system of claim 10, wherein the angle receiver is further configured to record the instantaneous angular position at the time when an image is received from the image sensor as the angular position corresponding to the received image and/or determine the plurality of angular positions by analyzing the plurality of images.

15. The system of claim 10, wherein the model constructor further configured to update the 3D model each time the image receiver receives a plurality of new images captured at a corresponding plurality of angular positions as the hinged door is being moved away from and/or towards a closed position.

16. The system of claim 10, further comprising:
the image sensor from which the modelling apparatus is configured to receive the plurality of images and/or an angle sensor from which the angle receiver is configured to receive the instantaneous angular position of the hinged door.

17. The system of claim 10, further comprising an image display configured to display an image rendered from the 3D model, wherein the image display is configured to be mounted on an exterior-facing side of the hinged door.

18. The system of claim 10, further comprising a headpose tracking device configured to track a headpose of a viewer of the image display configured to change the perspective from which the displayed image is rendered from the 3D model based on the headpose of the viewer.

19. A storage container comprising a hinged door, and the system of claim 10.

20. The storage container of claim 19, wherein the image sensor is moved relative to the hinged door in a direction parallel to the rotational axis of the hinged door as the angular position of the hinged door relative to the storage container changes.

21. The storage container of claim 19, wherein the storage container is a refrigerator or a refrigerator compartment.
